(19) United States
(12) Patent Application Publication
(10) Pub. No.: US 2024/0207719 A1
(43) Pub. Date: Jun. 27, 2024

(54) ILLUMINATED PLAYMAT SYSTEM

(71) Applicant: Abdoulaye Balde, Seattle, WA (US)

(72) Inventor: Abdoulaye Balde, Seattle, WA (US)

(21) Appl. No.: 18/456,583

(22) Filed: Aug. 28, 2023

Related U.S. Application Data
(60) Provisional application No. 63/434,534, filed on Dec. 22, 2022.

(51) Int. Cl. A63F 13/214; A63F 13/24

(52) U.S. Cl. CPC A63F 13/214; A63F 13/24; A63F 2300/1068

(57) ABSTRACT

An illuminated playmat system that provides a safe, easy to use, and enjoyable way to engage in an exercise, a dance, or a specific game. The illuminated playmat system includes a planar mat surface, a plurality of pressure sensors, a plurality of lights, a control unit, a power source, and a user interface. The control unit are responsible for processing data from the pressure sensors and triggering the lights accordingly. The user interface enables a user to select an exercise program, a dance program, a specific game program.

### CROSS REFERENCE TO RELATED APPLICATIONS

This application claims the benefit of U.S. Provisional Application No. 63/434,534 filed on Dec. 22, 2022. The above identified patent application is herein incorporated by reference in its entirety to provide continuity of disclosure.

### BACKGROUND OF THE INVENTION

The present invention relates to a playmat. More specifically, the present invention relates to an illuminated playmat system.

Body balance exercise may have positive effects of the physical, mental, and emotional health of children and adults. Currently, there is a distinct lack of bodily balance devices known in the art to provide individuals with the ability to engage in body balance exercises and activities. In particular, there is a lack of bodily balance devices that will improve physical, mental and emotional health in children and prevent Post-Traumatic Stress Disorder in adults.

The illuminated playmat system described herein seeks to remedy the lack of available devices for providing a safe, easy to use, and enjoyable way to engage in bodily balance exercises and activities. The illuminated playmat system seeks to provide a unique solution to the long-felt need for balance devices that will prevent behavioral problems, promote good body balance, and promote better focus for success.

### SUMMARY OF THE INVENTION

In view of the foregoing disadvantages inherent in the known types of illuminated playmat systems now present in the prior art, the present invention provides an illuminated playmat system wherein the same may be utilized for providing convenience for the user when using an illuminated playmat system.

The present system comprises an illuminated playmat system having a planar mat surface adapted to be stepped onto by a user to perform an exercise, a dance, or a specific game, a plurality of pressure sensors embedded into the planar mat surface, the pressure sensors detect when the planar mat surface is stepped onto in order to perform the exercise, the dance, or the specific game, and the pressure sensors are arranged in a layout for the exercise, the dance, or the specific game, a plurality of lights illuminated in response to pressure or movement detected by the pressure sensors when the planar mat surface is stepped onto in order to perform the exercise, the dance, or the specific game, a control unit processing data from the pressure sensors and triggering the lights accordingly, a power source providing electrical power to the planar mat surface, and a user interface having a display that enables a user adapted to select the exercise, the dance, or the specific game.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of an embodiment of an illuminated playmat system.

FIG. 2 shows an overhead view of an embodiment of the illuminated playmat system.

FIG. 3 shows an overhead view of an embodiment of the illuminated playmat system.

FIG. 4 shows an overhead view of an embodiment of the illuminated playmat system.

FIG. 5 shows an overhead view of an embodiment of the illuminated playmat system.

FIG. 6 shows an overhead view of an embodiment of the illuminated playmat system.

FIG. 7 shows an overhead view of an embodiment of the illuminated playmat system.

FIG. 8 shows an overhead view of an embodiment of the illuminated playmat system.

FIG. 9 shows an overhead view of an embodiment of the illuminated playmat system.

FIG. 10 shows an overhead view of an embodiment of the illuminated playmat system.

FIG. 11 shows a plurality of overhead views of a plurality of embodiments of the illuminated playmat system.

FIG. 12 shows a plurality of overhead views of a plurality of embodiments of the illuminated playmat system.

FIG. 13 shows a plurality of overhead views of a plurality of embodiments of the illuminated playmat system.

FIG. 14 shows a plurality of overhead views of a plurality of embodiments of the illuminated playmat system.

FIG. 15 shows a side perspective view of an embodiment of the illuminated playmat system.

FIG. 16 shows a side perspective view of an embodiment of the illuminated playmat system.

### DETAILED DESCRIPTION OF THE INVENTION

Reference is made herein to the attached drawings. Like reference numerals are used throughout the drawings to depict like or similar elements of the illuminated playmat system. The figures are intended for representative purposes only and should not be considered to be limiting in any respect.

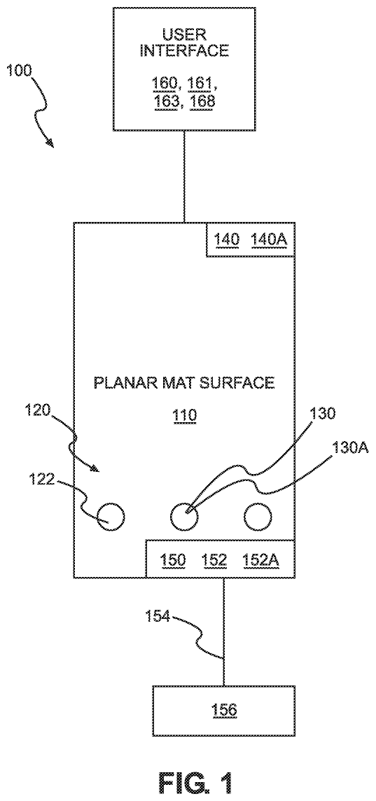

FIG. 1 shows a system overview of an embodiment of an illuminated playmat system 100.

The illuminated playmat system 100 may include a planar mat surface 110, a plurality of pressure sensors 120, a plurality of lights 130, a control unit 140, a power source 150, and a user interface 160.

The planar mat surface 110 may be stepped onto or the like in order to perform an exercise, a dance, a specific game, or the like. The planar mat surface 110 may have a general rectangular shape or the like. The planar mat surface 110 may be made of a relatively soft material or the like. More specifically, the planar mat surface 110 may be made of a recycled plastic material or the like. However, in alternate embodiments, the planar mat surface 110 may be made of any material of suitable comfort and durability.

The pressure sensors 120 may be embedded into the planar mat surface 110 or the like and detect when the planar mat surface 110 may be stepped onto in order to perform an exercise, a dance, a specific game, or the like. The pressure sensors 120 may be arranged in a layout 122 for a specific game, dance, or the like. For example, the pressure sensors 120 may be arranged in a line, a square, a circle, or any other suitable shape as contemplated by a user. The pressure sensors 120 may be configured to illuminate in a series of programmed patterns to guide a user through a series of movements or gameplay.

The lights 130 may be illuminated in response to pressure or movement detected by the pressure sensors 120 when the planar mat surface 110 may be stepped onto in order to perform an exercise, a dance, a specific game, or the like. The lights 130 may be a light emitting diode light or LED light 130A or the like. Upon actuation of the lights 130 associated with the pressure sensors 120, the illuminated light source is deactivated and a subsequent light source in the programmed pattern is illuminated. The patterns may be configured to simulate various existing games or movement to entice individuals to be more active.

The control unit 140 may be a microcontroller 140A or the like. The control unit 140 may be responsible for processing data from the pressure sensors 120 and triggering the lights 130 accordingly. The control unit 140 may also manage the timing and sequencing of a user's steps and activities.

The power source 150 may provide electrical power to the planar mat surface 110. The power source 150 may be a battery 152 such as a rechargeable battery 152A or the like. The power source 150 may be a power cord 154 and an electric plug 152 that is inserted into an electrical outlet 156 or the like.

The user interface 160 may include a display 162 such as a digital display 162A, an analog display 162B or the like with a plurality of buttons 164 and/or a plurality of switches 166 or the like. The user interface 160 may enable a user to select an exercise program, a dance program, a specific game program, or the like.

In some embodiments, the user interface 160 may include a big screen 168 that may display a robotic video simulating a game 161 being visualized on the illuminated playmat system 100. In other embodiments, the illuminated playmat system 100 may comprise a speaker 163 that gives audio guides to assist a user with how to engage the illuminated playmat system 100.

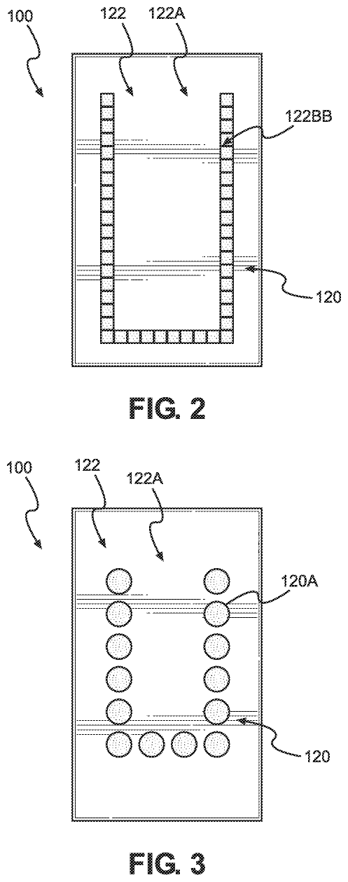

FIG. 2 shows an overhead view of an embodiment of the illuminated playmat system 100.

The pressure sensors 120 may be arranged in a layout 122 that has a linear U-shape 122A with a plurality of equidistant lines 122BB extending outward from the linear U-shape 122A.

FIG. 3 shows an overhead view of an embodiment of the illuminated playmat system 100.

The pressure sensors 120 may each have a circular shape 120A that may be arranged in a layout 122 that has a linear U-shape 122A.

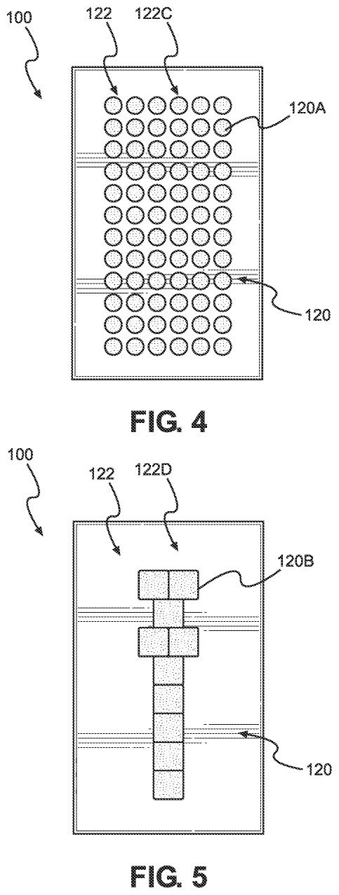

FIG. 4 shows an overhead view of an embodiment of the illuminated playmat system 100.

The pressure sensors 120 may each have a circular shape 120A that may be arranged in a layout 122 that has a generally rectangular shape 122C or the like.

FIG. 5 shows an overhead view of an embodiment of the illuminated playmat system 100.

The pressure sensors 120 may each have a square shape 120B that may be arranged in a layout 122 that has a single vertical and double horizontal shape 122D or the like.

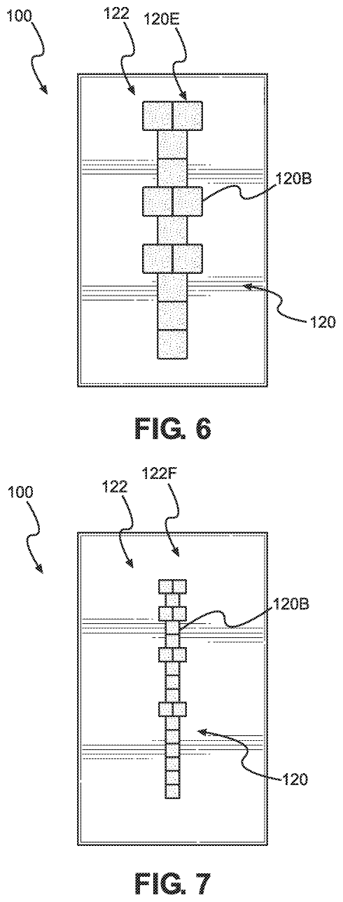

FIG. 6 shows an overhead view of an embodiment of the illuminated playmat system 100.

The pressure sensors 120 may each have a square shape 120B that may be arranged in a layout 122 that has a single vertical and triple horizontal shape 122E or the like.

FIG. 7 shows an overhead view of an embodiment of the illuminated playmat system 100.

The pressure sensors 120 may each have a square shape 120B that may be arranged in a layout 122 that has a single vertical and quadruple horizontal shape 122F or the like.

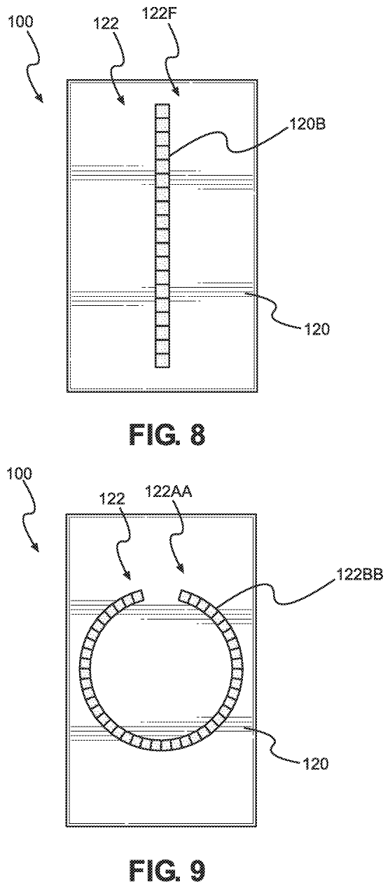

FIG. 8 shows an overhead view of an embodiment of the illuminated playmat system 100.

The pressure sensors 120 may each have a square shape 120B that may be arranged in a layout 122 that has a single vertical shape 122F or the like.

FIG. 9 shows an overhead view of an embodiment of the illuminated playmat system 100.

The pressure sensors 120 may be arranged in a layout 122 that has a linear circular shape 122AA with a plurality of equidistant lines 122BB extending outward from the linear circular shape 122AA.

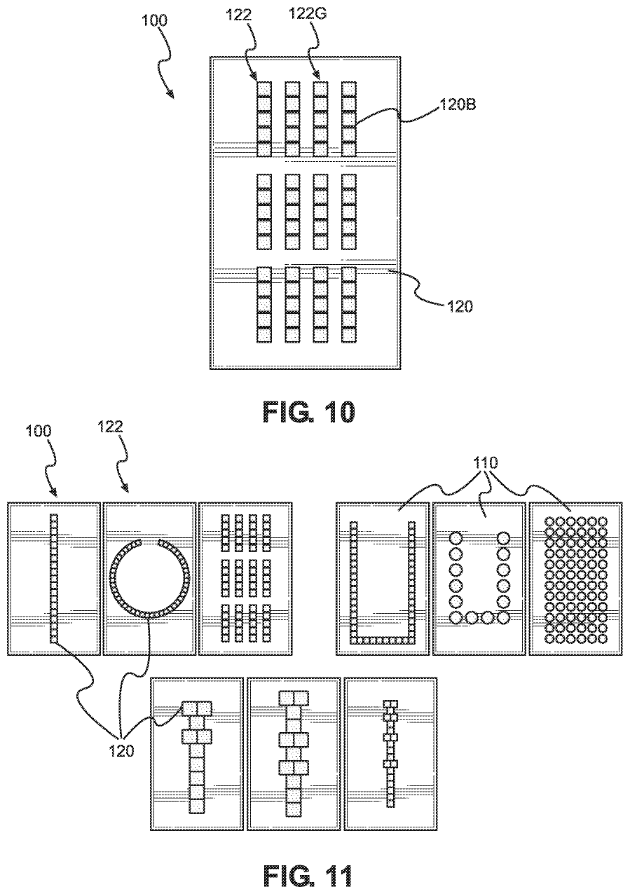

FIG. 10 shows an overhead view of the illuminated playmat system 100.

The pressure sensors 120 may each have a square shape 120B that is arranged in a layout 122 that has a 3 sets of 4 linear vertical lines 122G.

FIG. 11 shows an overhead view of the illuminated playmat system 100.

The pressure sensors 120 may have 3 sets of 3 planar mat surfaces 110 having a plurality of layouts 122.

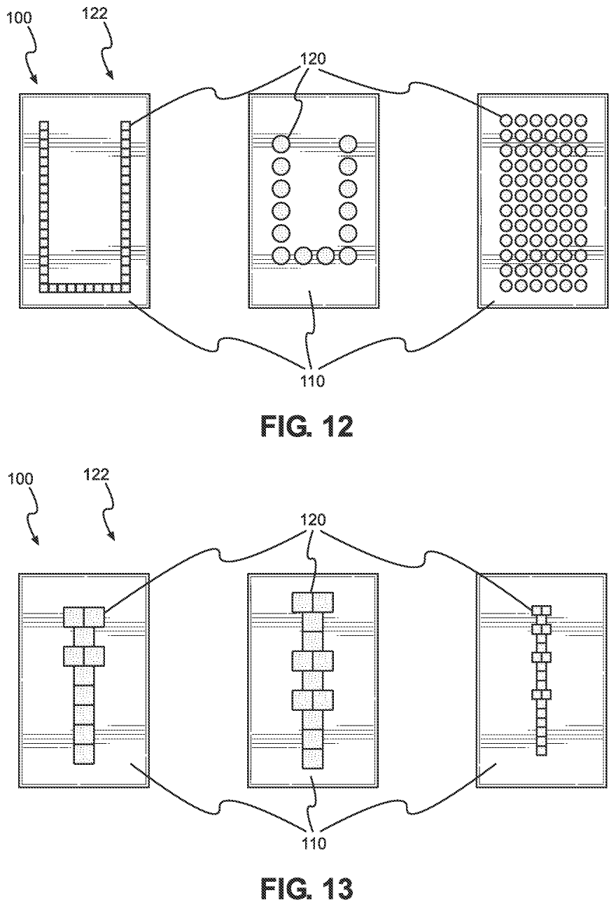

FIG. 12 shows an overhead view of the illuminated playmat system 100.

The pressure sensors 120 may have a first single set of 3 planar mat surfaces 110 having a plurality of layouts 122.

FIG. 13 shows an overhead view of the illuminated playmat system 100.

The pressure sensors 120 may have a second single set of 3 planar mat surfaces 110 having a plurality of layouts 122.

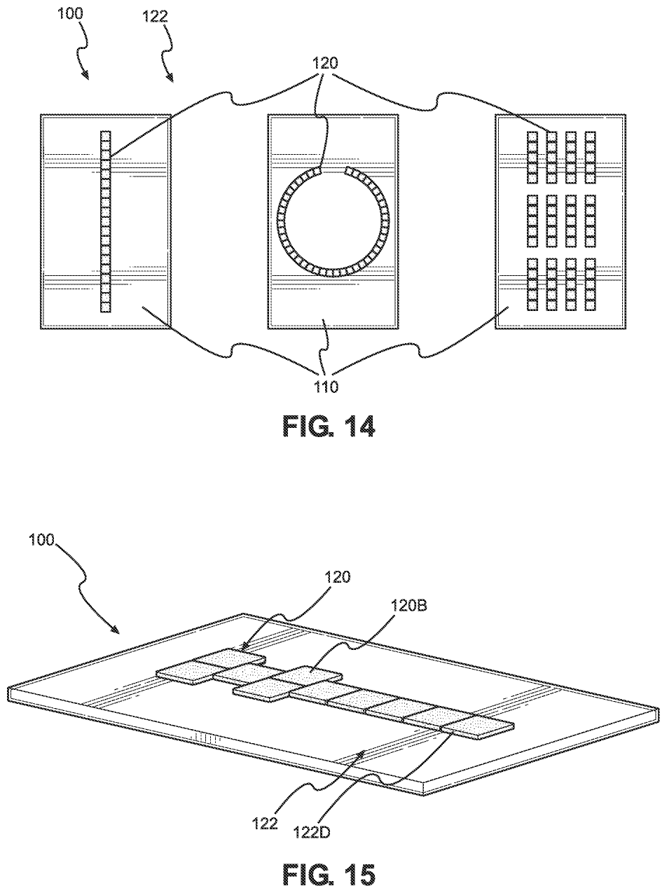

FIG. 14 shows an overhead view of an embodiment of the illuminated playmat system 100.

The pressure sensors 120 may have a third single set of 3 planar mat surfaces 110 having a plurality of layouts 122.

FIG. 15 shows a side perspective view of an embodiment of the illuminated playmat system 100.

The pressure sensors 120 may each have a square shape 120B that may be arranged in a layout 122 that has a single vertical and double horizontal shape 122D or the like.

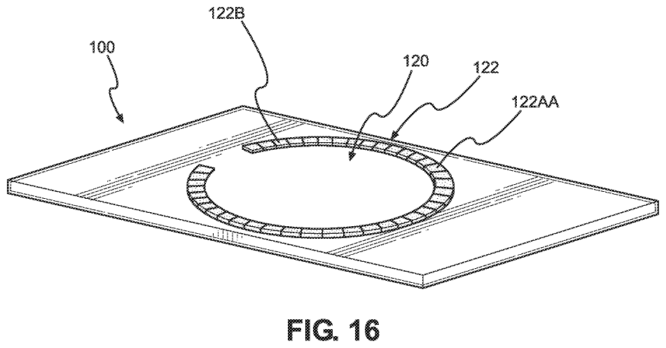

FIG. 16 shows a side perspective view of an embodiment of the illuminated playmat system 100.

The pressure sensors 120 may be arranged in a layout 122 that has a linear circular shape 122AA with a plurality of equidistant lines 122B extending outward from the linear circular shape 122AA.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An illuminated playmat system, comprising:
a planar mat surface adapted to be stepped onto by a user to perform an exercise, a dance, or a specific game;
a plurality of pressure sensors embedded into the planar mat surface, the pressure sensors detect when the planar mat surface is stepped onto in order to perform the exercise, the dance, or the specific game, and the pressure sensors are arranged in a layout for the exercise, the dance, or the specific game;
a plurality of lights illuminated in response to pressure or movement detected by the pressure sensors when the planar mat surface is stepped onto in order to perform the exercise, the dance, or the specific game;
a control unit processing data from the pressure sensors and triggering the lights accordingly;
a power source providing electrical power to the planar mat surface; and
a user interface having a display that enables a user adapted to select the exercise, the dance, or the specific game.

2. The illuminated playmat system, according to claim 1, wherein the planar mat surface has a general rectangular shape.

3. The illuminated playmat system, according to claim 1, wherein the planar mat surface is made of a soft material.

4. The illuminated playmat system, according to claim 3, wherein the soft material is made of a recycled plastic material.

5. The illuminated playmat system, according to claim 1, wherein the pressure sensors illuminate in a series of programmed patterns.

6. The illuminated playmat system, according to claim 1, wherein the pressure sensors are selected from the group consisting of the pressure sensors each have a linear circular shape with a plurality of equidistant lines extending outward from the linear circular shape that is arranged in the layout that has a linear U-shape, the pressure sensors each have the circular shape that is arranged in the layout that has a generally rectangular shape, the pressure sensors each have a square shape that are arranged in the layout that has a vertical linear shape and a double horizontal linear shape, the pressure sensors each have the square shape that is arranged in the layout that has the vertical linear shape and a quadruple horizontal line shape, the pressure sensors each have the square shape that is arranged in the layout that has the single vertical shape, the pressure sensors are arranged in the layout that has the linear circular shape with a plurality of equidistant lines extending outward from the linear circular shape, the pressure sensors each have the square shape that is arranged in the layout that has 3 sets of 4 linear vertical lines, the pressure sensors have 3 sets of 3 planar mat surfaces having a plurality of layouts, the pressure sensors have a second single set of 3 planar mat surfaces having the layouts, or the pressure sensors have a third single set of 3 planar mat surfaces having the layouts.

7. The illuminated playmat system, according to claim 1, wherein the layout has the linear U-shape with a plurality of equidistant lines extending outward from the linear U-shape.

8. The illuminated playmat system, according to claim 1, wherein the lights are a plurality of LED lights.

9. The illuminated playmat system, according to claim 1, wherein the control unit manages the timing and sequencing of a user's steps and activities.

10. The illuminated playmat system, according to claim 1, wherein the control unit is a microcontroller.

11. The illuminated playmat system, according to claim 1, wherein the power source is a battery.

12. The illuminated playmat system, according to claim 11, wherein the battery is a rechargeable battery.

13. The illuminated playmat system, according to claim 1, wherein the power source is a power cord and an electric plug that is adapted to be inserted into an electrical outlet.

14. The illuminated playmat system, according to claim 1, wherein the display is a digital display that includes a plurality of digital buttons and/or a plurality of digital switches.

15. The illuminated playmat system, according to claim 1, wherein the user interface includes a big screen.

16. The illuminated playmat system, according to claim 15, wherein the big screen displays a robotic video simulating a game.

17. The illuminated playmat system, according to claim 16, wherein the big screen displays the robotic video simulating the game being visualized.

18. The illuminated playmat system, according to claim 1, wherein the display is an analog display.

19. The illuminated playmat system, according to claim 18, wherein the analog display includes a plurality of buttons and/or a plurality of switches.

20. The illuminated playmat system, according to claim 19, further comprising a speaker that gives audio guides adapted to assist the user with how to engage the illuminated playmat system.
